(19) United States
(12) Patent Application Publication
(10) Pub. No.: US 2025/0300158 A1
(43) Pub. Date: Sep. 25, 2025

(54) ALL SOLID BATTERY

(71) Applicant: TAIYO YUDEN CO., LTD., Tokyo (JP)

(72) Inventor: Maki INOUE, Tokyo (JP)

(73) Assignee: TAIYO YUDEN CO., LTD., Tokyo (JP)

(21) Appl. No.: 19/065,328

(22) Filed: Feb. 27, 2025

(30) Foreign Application Priority Data
Mar. 21, 2024 (JP) 2024-045309

(51) Int. Cl. H01M 4/04

(52) U.S. Cl. CPC H01M 4/0407; H01M 4/0414; H01M 4/0471

(57) ABSTRACT

An all solid battery includes a first overlapping portion in which a tip of a first internal electrode layer and a part of a first margin overlap each other, viewed along a stacking direction. 0°<θ<90° and 0.1×t1/tan θ≤d<2.0×t1/tan θ are satisfied when in the first overlapping portion, an angle formed by a straight line connecting a tip point E1 of the first internal electrode layer on the first margin side and a tip point E2 of the first margin on the first internal electrode layer side and a straight line connecting both ends of the first internal electrode layer is “θ”, a thickness of the first margin is “t1”, and a length between the tip point E1 and the tip point E2 in the third direction is “d”.

### CROSS-REFERENCE TO RELATED APPLICATION

This application is based upon and claims the benefit of priority of the prior Japanese Patent Application No. 2024-045309, filed on Mar. 21, 2024, the entire contents of which are incorporated herein by reference.

### FIELD

A certain aspect of the present invention relates to an all solid battery.

### BACKGROUND

Multilayer all solid batteries are safe and easy to handle secondary batteries that do not pose the risk of fire or leakage and can be reflow soldered (see, for example, Japanese Patent Application Publication No. 2014-116136). There are plans to replace conventional lithium-ion batteries that use electrolytes with the all solid batteries. And it is expected that the all solid batteries will be used in a wide range of fields.

### SUMMARY OF THE INVENTION

According to an aspect of the present invention, there is provided an all solid battery including: a solid electrolyte layer that has a first main face and a second main face facing each other in a first direction, has a first end face and a second end face facing each other in a second direction orthogonal to the first direction, and has a first side face and a second side face facing each other in a third direction orthogonal to the first direction and the second direction; a first internal electrode layer that is formed on the first main face of the solid electrolyte layer and is drawn to the first end face; a second internal electrode layer that is formed on the second main face of the solid electrolyte layer and is drawn to the second end face; a first margin that is formed around the first internal electrode layer on the first main face of the solid electrolyte layer and has a composition different from those of the solid electrolyte layer and the first internal electrode layer; a second margin that is formed around the second internal electrode layer on the second main face of the solid electrolyte layer and has a composition different from those of the solid electrolyte layer and the second internal electrode layer; a first overlapping portion in which a tip of the first internal electrode layer and a part of the first margin overlap each other in the third direction, viewed along the first direction; and a second overlapping portion in which a tip of the second internal electrode layer and a part of the second margin overlap each other in the third direction, viewed along the first direction, wherein 0°<θ<90° and 0.1×t1/tan θ≤d≤2.0×t1/tan θ are satisfied when in the first overlapping portion, an angle formed by a straight line connecting a tip point E1 of the first internal electrode layer on the first margin side in the third direction and a tip point E2 of the first margin on the first internal electrode layer side in the third direction and a straight line connecting both ends of the first internal electrode layer in the third direction is “θ”, a thickness of the first margin in the first direction is “t1”, and a length between the tip point E1 and the tip point E2 in the third direction is “d”.

According to an aspect of the present invention, there is provided an all solid battery including: a solid electrolyte layer that has a first main face and a second main face facing each other in a first direction, has a first end face and a second end face facing each other in a second direction orthogonal to the first direction, and has a first side face and a second side face facing each other in a third direction orthogonal to the first direction and the second direction; a first internal electrode layer that is formed on the first main face of the solid electrolyte layer and is drawn to the first end face; a second internal electrode layer that is formed on the second main face of the solid electrolyte layer and is drawn to the second end face; a first margin that is formed around the first internal electrode layer on the first main face of the solid electrolyte layer and has a composition different from those of the solid electrolyte layer and the first internal electrode layer; a second margin that is formed around the second internal electrode layer on the second main face of the solid electrolyte layer and has a composition different from those of the solid electrolyte layer and the second internal electrode layer; a first overlapping portion in which a tip of the first internal electrode layer and a part of the first margin overlap each other in the third direction, viewed along the first direction; and a second overlapping portion in which a tip of the second internal electrode layer and a part of the second margin overlap each other in the third direction, viewed along the first direction, wherein in a case where in the first overlapping portion, a first tip point of the first internal electrode layer on the first margin side in the third direction is a tip point E1 and a tip point of the first margin on the first internal electrode layer side in the third direction is a tip point E2, when the tip point E1 is located on one side in the first direction in a thickness of the first internal electrode layer, an outer shape of the first internal electrode layer is curved so as to be convex on the other side in the first direction.

### BRIEF DESCRIPTION OF THE DRAWINGS

FIG. 1 illustrates a schematic cross sectional view of a basic structure of an all solid battery;

FIG. 2 illustrates a schematic partial cross-sectional perspective view of a stacked all-solid-state battery in which battery units are stacked;

FIG. 3 illustrates a cross sectional view taken along a line A-A of FIG. 2;

FIG. 4 illustrates a cross sectional view taken along a line B-B of FIG. 2;

FIG. 5A illustrates a enlarged view of a cross section of a side margin;

FIG. 5B illustrates an enlarged view of a cross section of a first end margin;

FIG. 6 is an enlarged cross-sectional view of ta boundary between a first margin and a first internal electrode layer;

FIG. 7 is an enlarged cross-sectional view of ta boundary between a first margin and a first internal electrode layer;

FIG. 8 is an enlarged cross-sectional view of ta boundary between a first margin and a first internal electrode layer;

FIG. 9 illustrates a flowchart of a manufacturing method of an all solid battery;

FIG. 10A and FIG. 10B illustrate a stacking process;

FIG. 11 illustrates a stacking process; and

FIG. 12 illustrates a printing process.

### DETAILED DESCRIPTION

From the viewpoint of ensuring battery capacity, it is preferable that the end of the internal electrode layer is not thin. However, when charging and discharging are repeated, the internal electrode layer repeatedly expands and contracts in volume. Therefore, if the end of the internal electrode layer is thick, interfacial cracks may occur between the solid electrolyte layer and the internal electrode layer, and the battery characteristics may deteriorate. Therefore, from the viewpoint of suppressing interfacial cracks, it is preferable that the end of the internal electrode layer is thin at the tip and gradually becomes thicker from the tip toward the inside.

However, if an attempt is made to realize a shape at the end of the internal electrode layer that gradually becomes thicker from the tip toward the inside, there is a risk of battery characteristics and reliability decreasing due to misalignment between the solid electrolyte layer and the internal electrode layer, deformation or poor compression during crimping, deformation during sintering, or the like. In addition, there is a risk of cracks occurring due to deformation during crimping, which may decrease the yield rate.

A description will be given of an embodiment with reference to the accompanying drawings.

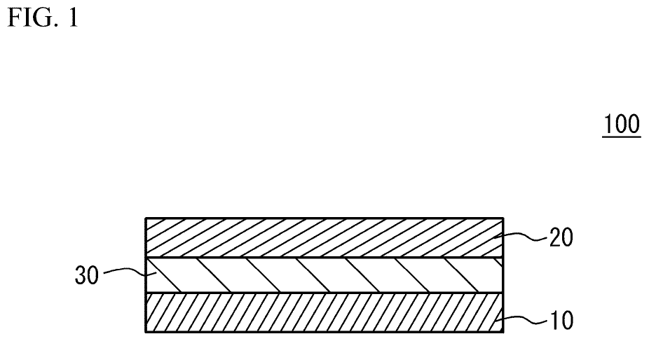

(Embodiment) FIG. 1 illustrates a schematic cross sectional view of a basic structure of an all solid battery 100 in accordance with an embodiment. As illustrated in FIG. 1, the all solid battery 100 has a structure in which a first internal electrode layer 10 and a second internal electrode layer 20 sandwich a solid electrolyte layer 30. The first internal electrode layer 10 is provided on a first main face of the solid electrolyte layer 30. The second internal electrode layer 20 is provided on a second main face of the solid electrolyte layer 30. For example, the first internal electrode layer 10, the second internal electrode layer 20 and the solid electrolyte layer 30 have a sintered body which is formed by sintering powder materials.

When the all solid battery 100 is used as a secondary battery, one of the first internal electrode layer 10 and the second internal electrode layer 20 is used as a positive electrode and the other is used as a negative electrode. In the embodiment, as an example, the first internal electrode layer 10 is used as a positive electrode, and the second internal electrode layer 20 is used as a negative electrode.

A main component of the solid electrolyte layer 30 is an oxide-based solid electrolyte having a NASICON crystal structure and having ion conductivity. For example, phosphoric acid salt-based electrolyte having a NASICON structure may be used for the solid electrolyte layer 30. The phosphoric acid salt-based solid electrolyte having the NASICON crystal structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓTi₂₋ₓ(PO₄)₃ or the like. For example, it is preferable that Li-Al-Ge-PO₄-based material, to which a transition metal included in the phosphoric acid salt having the olivine type crystal structure included in the first internal electrode layer 10 and the second internal electrode layer 20 is added in advance, is used. For example, when the first internal electrode layer 10 and the second internal electrode layer 20 include phosphoric acid salt including Co and Li, it is preferable that the solid electrolyte layer 30 includes Li-Al-Ge-PO₄-based material to which Co is added in advance. In this case, it is possible to suppress solving of the transition metal included in the electrode active material into the electrolyte. When the first internal electrode layer 10 and the second internal electrode layer 20 include phosphoric acid salt including Li and a transition metal other than Co, it is preferable that the solid electrolyte layer 30 includes Li-Al-Ge-PO₄-based material in which the transition metal is added in advance.

At least, the first internal electrode layer 10 used as the positive electrode includes a material having an olivine type crystal structure, as an electrode active material. It is preferable that the second internal electrode layer 20 also includes the electrode active material. The electrode active material is such as phosphoric acid salt including a transition metal and lithium. The olivine type crystal structure is a crystal of natural olivine. It is possible to identify the olivine type crystal structure, by using X-ray diffraction.

For example, LiCoPO₄ including Co may be used as a typical example of the electrode active material having the olivine type crystal structure. Other salts of phosphoric acid, in which Co acting as a transition metal is replaced to another transition metal in the above-mentioned chemical formula, may be used. A ratio of Li or PO₄ may fluctuate in accordance with a valence. It is preferable that Co, Mn, Fe, Ni or the like is used as the transition metal.

The electrode active material having the olivine type crystal structure acts as a positive electrode active material in the first internal electrode layer 10 acting as the positive electrode. For example, when only the first internal electrode layer 10 includes the electrode active material having the olivine type crystal structure, the electrode active material acts as the positive electrode active material. When the second internal electrode layer 20 also includes an electrode active material having the olivine type crystal structure, discharge capacity may increase and an operation voltage may increase because of electric discharge, in the second internal electrode layer 20 acting as the negative electrode. The function mechanism is not completely clear. However, the mechanism may be caused by partial solid-phase formation together with the negative electrode active material.

When both the first internal electrode layer 10 and the second internal electrode layer 20 include an electrode active material having the olivine type crystal structure, the electrode active material of each of the first internal electrode layer 10 and the second internal electrode layer 20 may have a common transition metal. Alternatively, the a transition metal of the electrode active material of the first internal electrode layer 10 may be different from that of the second internal electrode layer 20. The first internal electrode layer 10 and the second internal electrode layer 20 may have only single type of transition metal. The first internal electrode layer 10 and the second internal electrode layer 20 may have two or more types of transition metal. It is preferable that the first internal electrode layer 10 and the second internal electrode layer 20 have a common transition metal. It is more preferable that the electrode active materials of the both electrode layers have the same chemical composition. When the first internal electrode layer 10 and the second internal electrode layer 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The second internal electrode layer 20 may include known material as the negative electrode active material. When only one of the electrode layers includes the negative electrode active material, it is clarified that the one of the electrode layers acts as a negative electrode and the other acts as a positive electrode. When only one of the electrode layers includes the negative electrode active material, it is preferable that the one of the electrode layers is the second internal electrode layer 20. Both of the electrode layers may include the known material as the negative electrode active material. Conventional technology of secondary batteries may be applied to the negative electrode active material. For example, titanium oxide, lithium-titanium complex oxide, lithium-titanium complex salt of phosphoric acid salt, a carbon, a vanadium lithium phosphate.

In the forming process of the first internal electrode layer 10 and the second internal electrode layer 20, moreover, oxide-based solid electrolyte material or a conductive material (conductive auxiliary agent) may be added. When the material is evenly dispersed into water or organic solution together with binder or plasticizer, paste for electrode layer is obtained. In the embodiment, the electrode layer paste includes a carbon material as the conductive auxiliary agent. Moreover, the electrode may include a metal as the conductive auxiliary agent. Pd, Ni, Cu, or Fe, or an alloy thereof may be used as a metal of the conductive auxiliary agent. The solid electrolyte included in the first internal electrode layer 10 and the second internal electrode layer 20 may be the same as the solid electrolyte which is the main component of the solid electrolyte layer 30.

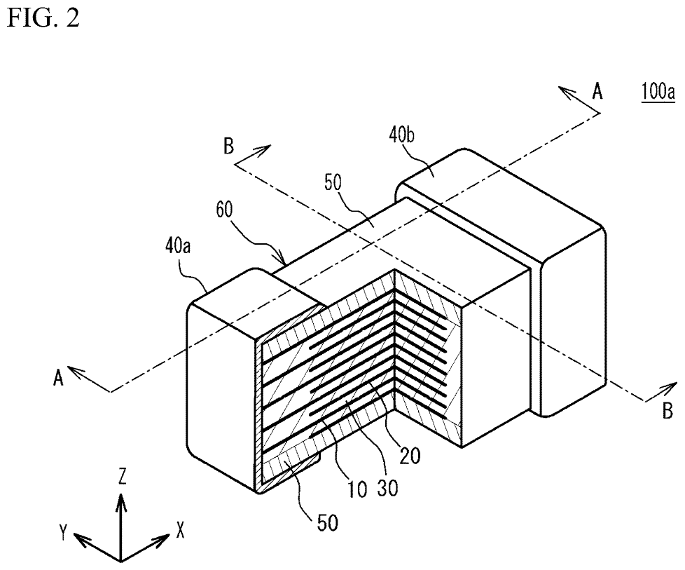

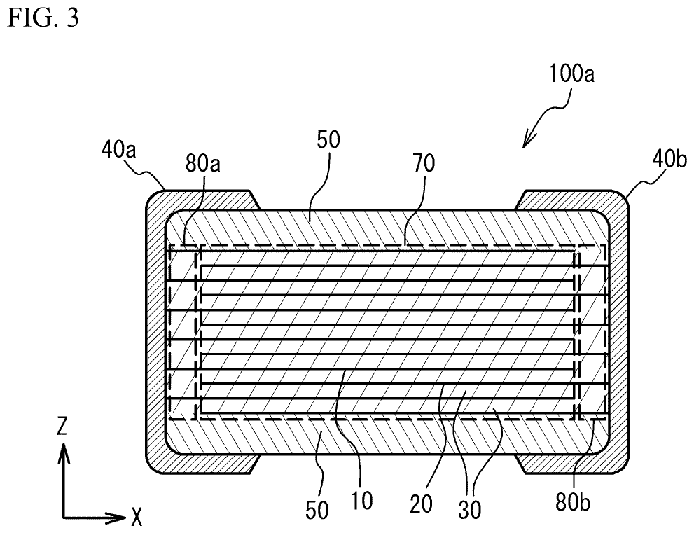

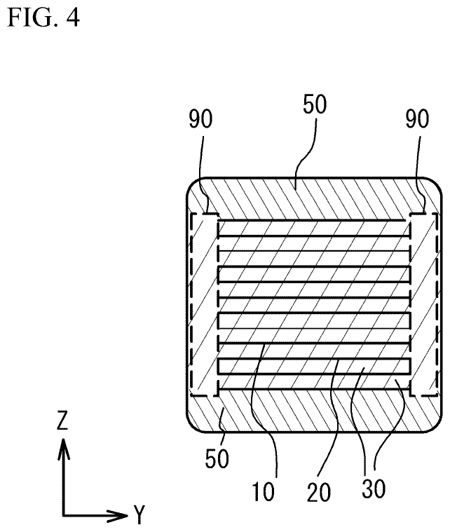

FIG. 2 is a partial cross-sectional perspective view of a multilayer type all solid battery 100a in which a plurality of battery units are stacked. FIG. 3 is a cross-sectional view taken along a line A-A in FIG. 2. FIG. 4 is a sectional view taken along a line B-B in FIG. 2. The all solid battery 100a includes a multilayer chip 60 having a substantially rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In FIG. 2 to FIG. 4, the Z-axis direction (first direction) is the stacking direction, and is the direction in which the upper face and the lower face of the multilayer chip 60 face each other. The X-axis direction (second direction) is the direction in which the two end faces of the multilayer chip 60 face each other, and is the facing direction in which the first external electrode 40a and the second external electrode 40b face each other. The Y-axis direction (third direction) is the width direction of the first internal electrode layer 10 and the second internal electrode layer 20, and is the facing direction in which two of the four side faces of the multilayer chip 60 other than the two end faces face each other. The X-axis direction, the Y-axis direction, and the Z-axis direction are mutually orthogonal to each other.

In the following description, the same numeral is added to each member that has the same composition range, the same thickness range and the same particle distribution range as that of the all solid battery 100. And, a detail explanation of the same member is omitted.

In the all solid battery 100a, the plurality of first internal electrode layers 10 and the plurality of second internal electrode layers 20 are alternately stacked with the solid electrolyte layers 30 in between. The edges of the plurality of first internal electrode layers 10 in the X-axis direction are exposed to the first end face of the multilayer chip 60 and are not exposed to the second end face. The edges of the plurality of second internal electrode layers 20 in the X-axis direction are exposed to the second end face of the multilayer chip 60 and are not exposed to the first end face. Thereby, the first internal electrode layer 10 and the second internal electrode layer 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of battery units are stacked.

A cover layer 50 is stacked on the upper end surface of the stacked portion of the first internal electrode layer 10, the solid electrolyte layer 30 and the second internal electrode layer 20. The cover layer 50 is in contact with the uppermost internal electrode layer (either one of the first internal electrode layer 10 and the second internal electrode layer 20) and is in contact with part of the solid electrolyte layer 30. Another cover layer 50 is also stacked on the lower end surface of the stacked portion. The cover layer 50 is in contact with the lowermost internal electrode layer (either one of the first internal electrode layer 10 and the second internal electrode layer 20) and is in contact with part of the solid electrolyte layer 30. For example, the cover layer 50 is a sintered body obtained by sintering powder material.

As illustrated in FIG. 3, a section where the first internal electrode layer 10 connected to the first external electrode 40a and the second internal electrode layer 20 connected to the second external electrode 40b face each other produces a battery capacity. Therefore, the section is called a battery capacity section 70. That is, the battery capacity section 70 is the section where two adjacent internal electrode layers connected to different external electrodes face each other.

A section where the first internal electrode layers 10 connected to the first external electrode 40a face each other without interposing the second internal electrode layer 20 connected to the second external electrode 40b is referred to as a first end margin 80a. Further, a section where the second internal electrode layers 20 connected to the second external electrode 40b face each other without interposing the first internal electrode layer 10 connected to the first external electrode 40a is referred to as a second end margin 80b. That is, the end margin is a section where internal electrode layers connected to the same external electrode face each other without interposing an internal electrode layer connected to a different external electrode. The first end margin 80a and the second end margin 80b are sections that do not produce battery capacity.

As illustrated in FIG. 4, in the multilayer chip 60, the section from the two side faces of the multilayer chip 60 to the first internal electrode layers 10 and the second internal electrode layers 20 is referred to as a side margin 90. That is, the side margin 90 is a section provided so as to cover the ends of the plurality of stacked first internal electrode layers 10 and second internal electrode layers 20 extending toward the two side surfaces in the multilayer portion.

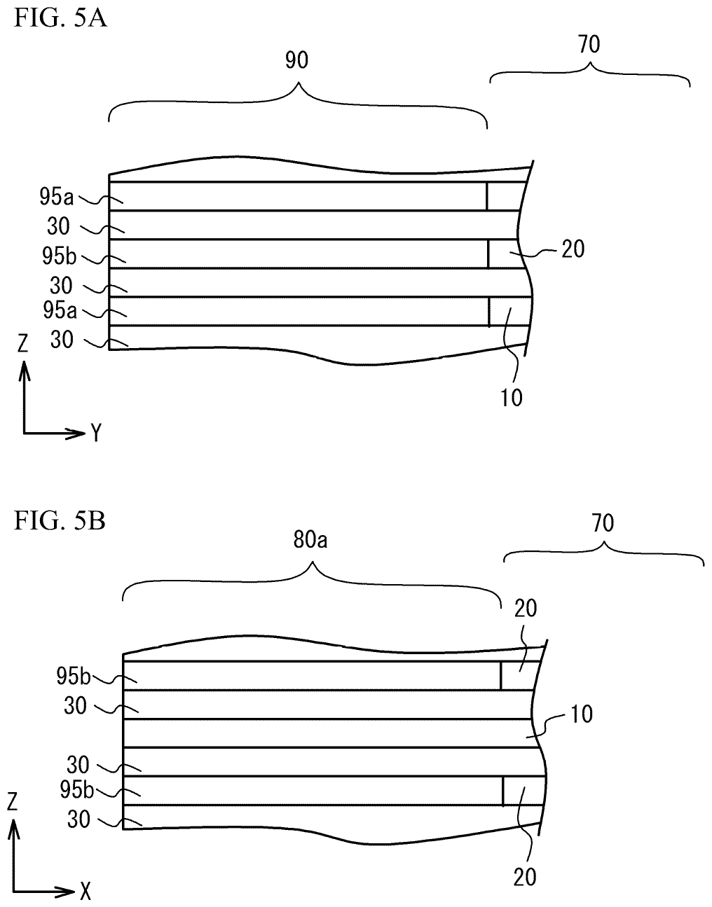

FIG. 5A is an enlarged view of a cross section of the side margin 90. The side margin 90 has a structure in which the solid electrolyte layers 30 and margins are alternately stacked in the stacking direction of the first internal electrode layer 10 and the second internal electrode layer 20 in the battery capacity section 70. A first margin 95a is provided in the same layer as the first internal electrode layer 10. A second margin 95b is provided in the same layer as the second internal electrode layer 20. With this configuration, the step between the battery capacity section 70 and the side margin 90 is suppressed.

The first margin 95a and the second margin 95b have a different composition from the solid electrolyte layer 30. For example, the main component of the first margin 95a and the second margin 95b may be the same as the main component of the solid electrolyte layer 30, and the additive element in the first margin 95a and the second margin 95b may be different from the additive element in the solid electrolyte layer 30. Alternatively, the main component of the first margin 95a and the second margin 95b may be the same as the main component of the solid electrolyte layer 30, the additive element in the first margin 95a and the second margin 95b may be the same as the additive element in the solid electrolyte layer 30, and the concentration of the additive element in the first margin 95a and the second margin 95b may be different from the concentration of the additive element in the solid electrolyte layer 30. Alternatively, the main component of the first margin 95a and the second margin 95b may be different from the main component of the solid electrolyte layer 30. Furthermore, the lithium ion conductivity in the first margin 95a and the second margin 95b is lower than the lithium ion conductivity in the solid electrolyte layer 30. When the XZ cross section or the YZ cross section is observed with a scanning electron microscope (SEM), interfaces can be observed between the first margin 95a and the second margin 95b and the solid electrolyte layer 30.

Furthermore, the first margin 95a does not contain an electrode active material or has a lower electrode active material concentration than the first internal electrode layer 10.

Furthermore, the second margin 95b does not contain an electrode active material or has a lower electrode active material concentration than the second internal electrode layer 20. Thereby, when observed with an SEM, an interface can be observed between the first margin 95a and the first internal electrode layer 10, and an interface can be observed between the second margin 95b and the second internal electrode layer 20.

For example, the material of the first margin 95a and the second margin 95b is glass, alumina, or the like.

FIG. 5B is an enlarged view of the cross section of the first end margin 80a. In the first end margin 80a, every other one of the multiple internal electrode layers that are stacked extends to the end face of the first end margin 80a. That is, in the first end margin 80a, the first internal electrode layer 10 extends to the end face, and the second internal electrode layer 20 does not extend to the end face. In the same layer as the second internal electrode layer 20, the second margin 95b is provided. Also, in the layer in which the first internal electrode layer 10 extends to the end face of the first end margin 80a, the first margin 95a is not stacked. With this configuration, the step between the battery capacity section 70 and the first end margin 80a is suppressed. In the second end margin 80b, the second internal electrode layer 20 extends to the end face, but the first internal electrode layer 10 does not extend to the end face. In the second end margin 80b, the first margin 95a is provided in the same layer as the first internal electrode layer 10.

From the viewpoint of ensuring battery capacity, it is preferable that the end of the internal electrode layer is not thin. However, when charging and discharging are repeated, the internal electrode layer repeats volume expansion and volume contraction. Therefore, if the end of the internal electrode layer is thick, interfacial cracks may occur between the solid electrolyte layer and the internal electrode layer, and the battery characteristics may deteriorate. Therefore, from the viewpoint of suppressing interfacial cracks, it is preferable that the end of the internal electrode layer is thin at the tip and gradually thickens from the tip inward.

However, if an attempt is made to realize a shape at the end of the internal electrode layer that gradually becomes thicker from the tip inward, there is a risk of a decrease in battery characteristics and reliability due to misalignment between the solid electrolyte layer and the internal electrode layer, deformation or poor compression during crimping, deformation during sintering, or the like. In addition, there is a risk of cracks occurring due to deformation during crimping, resulting in a decrease in the yield rate.

In contrast, the all solid battery 100a according to this embodiment has a configuration that can realize improved battery characteristics, improved reliability, and an improved yield rate. Details are explained below.

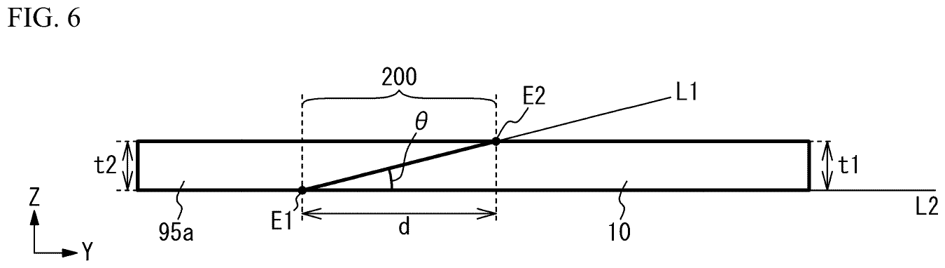

FIG. 6 is an enlarged cross-sectional view of the boundary between the first margin 95a and the first internal electrode layer 10. The relationship between the first margin 95a and the first internal electrode layer 10 will be described below, but the first margin 95a may be read as the second margin 95b, and the first internal electrode layer 10 may be read as the second internal electrode layer 20.

As illustrated in FIG. 6, in the YZ cross section, when viewed from the Z-axis direction, the first internal electrode layer 10 and the first margin 95a overlap in the Y-axis direction from the tip of the first internal electrode layer 10 on the first margin 95a side to the tip of the first margin 95a on the first internal electrode layer 10 side. This overlapping portion is referred to as an overlapping portion 200. In the overlapping portion 200, the first internal electrode layer 10 and the first margin 95a are not mixed with each other and exist independently.

In the overlapping portion 200, the thickness of the first internal electrode layer 10 gradually increases from the tip on the first margin 95a side toward the Y-axis direction. On the other hand, in the overlapping portion 200, the thickness of the first margin 95a gradually increases from the tip on the first internal electrode layer 10 side toward the opposite side in the Y-axis direction. With this configuration, the thickness of the overlapping portion 200 is approximately constant at different points in the Y-axis direction in the YZ cross section.

The length of the overlapping portion 200 in the Y-axis direction is referred to as a length “d”. The length “d” corresponds to the distance in the Y-axis direction from a tip point E1 of the first internal electrode layer 10 on the first margin 95a side to a tip point E2 of the first margin 95a on the first internal electrode layer 10 side. In the overlapping portion 200, the angle formed by a straight line L1 connecting the tip point E1 of the first internal electrode layer 10 on the first margin 95a side and the tip point E2 of the first margin 95a on the first internal electrode layer 10 side, and a straight line L2 connecting both ends of the first internal electrode layer 10 in the Y-axis direction, is referred to as the electrode end angle “θ”.

The thickness of the first internal electrode layer 10 is referred to as a thickness “t1”. The thickness “t1” can be measured by measuring the thickness at 10 different points in the Y-axis direction and calculating the average value. The thickness of the first margin 95a is referred to as a thickness “t2”. The thickness “t2” can be measured by measuring the thickness at 10 different points in the Y-axis direction and calculating the average value.

If the length “d” of the overlapping portion 200 is short, the thickness of the first internal electrode layer 10 in the overlapping portion 200 increases suddenly along the Y-axis direction, and this may result in a decrease in battery characteristics and reliability due to misalignment between the solid electrolyte layer 30 and the first internal electrode layer 10, deformation or poor compression during crimping, deformation during sintering, or the like. In addition, there is a risk that cracks may occur due to deformation during crimping, resulting in a decrease in yield rate. Therefore, in this embodiment, a lower limit is set for the length “d”. However, through intensive research by the inventor, it has been found that it is necessary to adjust the lower limit of the length “d” according to the thickness “t1” and angle “θ” of the first internal electrode layer 10. Specifically, in this embodiment, it has been found that the relationship 0°<θ<90° and 0.1×t1/tan θ≤d is required. The units of “d” and “t1” are “μm”, and the unit of “θ” is “degrees”.

On the other hand, if the length “d” of the overlapping portion 200 is long, there will be many regions where the thickness of the first internal electrode layer 10 is insufficient, and there is a risk that sufficient battery capacity will not be obtained. Therefore, in this embodiment, an upper limit is set for the length “d”. However, through intensive research by the inventor, it has been found that it is necessary to adjust the upper limit of the length “d” according to the thickness “t1” and angle “θ” of the first internal electrode layer 10. Specifically, it has been found that in this embodiment, the relationship d≤2.0×t1/tan θ is required.

As described above, by establishing the relationship 0°<θ<90° and 0.1×t1/tan θ≤d≤2.0×t1/tan θ, it is possible to realize improved battery characteristics, improved reliability, and improved yield rate.

From the viewpoint of making the length “d” of the overlapping portion 200 sufficiently long, it is preferable that the relationship 0.2×t1/tan θ≤d is satisfied, and it is more preferable that the relationship 0.3×t1/tan θ≤d is satisfied.

From the viewpoint of making the length “d” of the overlapping portion 200 sufficiently short, it is preferable that the relationship d≤1.9×t1/tan θ is satisfied, and it is more preferable that the relationship d≤1.8×t1/tan θ is satisfied.

From the viewpoint of making the length “d” of the overlapping portion 200 sufficiently long, it is preferable that the angle θ≤95°, and it is more preferable that the angle θ≤80°.

From the viewpoint of making the length “d” of the overlapping portion 200 sufficiently short, it is preferable that the angle θ≥5°, and it is more preferable that the angle θ≥10°.

The thickness “t1” of the first internal electrode layer 10 may be 1 μm or more and 200 μm or less, 1 μm or more and 1000 μm or less, or 1 μm or more and 2000 μm or less.

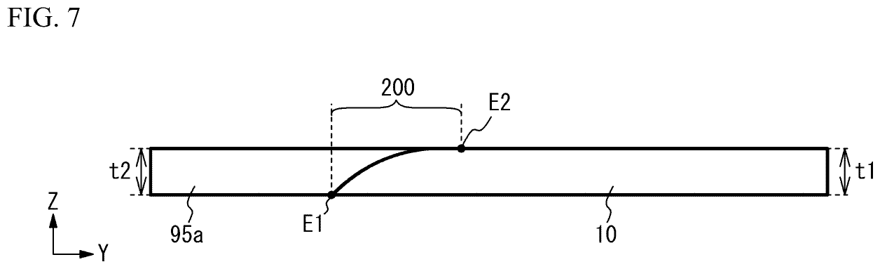

Next, as illustrated in FIG. 7, it is preferable that the external shape of the portion of the overlapping portion 200 where the first internal electrode layer 10 contacts the first margin 95a in the YZ cross section has a curvature. In this case, the contact area between the first internal electrode layer 10 and the first margin 95a is increased in the overlapping portion 200, and interfacial peeling between the first internal electrode layer 10 and the first margin 95a can be suppressed.

For example, it is preferable that the outer shape of the first internal electrode layer 10 has a curvature from the tip point E1 of the first internal electrode layer 10 on the first margin 95a side to the tip point E2 of the first margin 95a on the first internal electrode layer 10 side. For example, it is preferable that the outer shape of the first internal electrode layer 10 is curved so as to be convex on one side in the Z-axis direction from the tip point E1 to the tip point E2. For example, when the tip point E1 is located on one side in the Z-axis direction in the thickness of the first internal electrode layer 10, it is preferable that the outer shape of the first internal electrode layer 10 is curved so as to be convex on the other side in the Z-axis direction. In this case, the first internal electrode layer 10 can be made thick, and therefore the battery capacity can be increased.

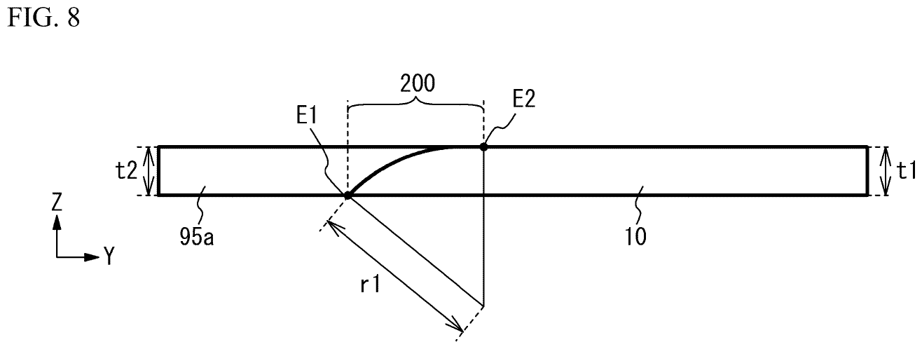

Here, a method for measuring the curvature of the outer shape of the first internal electrode layer 10 at the overlapping portion 200 in the YZ cross section will be described. As illustrated in FIG. 8, a circle passing through the two points, the tip point E1 and the tip point E2, is assumed. Furthermore, an approximate circle is created by fitting to the outer shape of the first internal electrode layer 10. The radius of this approximate circle is taken as the radius of curvature “r1”. The VHX series+measurement system VH-M100 manufactured by KEYENCE can be used to create the approximate circle.

If the radius of curvature “r1” is large, there is a risk that the contact area between the first internal electrode layer 10 and the first margin 95a may not be necessarily large enough. Therefore, it is preferable to set an upper limit to the radius of curvature “r1”. In this embodiment, the radius of curvature “r1” is preferably 500 μm or less, more preferably 200 μm or less, and even more preferably 100 μm or less.

On the other hand, if the radius of curvature “r1” is small, the film thickness increases rapidly, which may cause interface separation and lead to a short circuit. Therefore, it is preferable to set a lower limit for the radius of curvature “r1”. In this embodiment, the radius of curvature “r1” is preferably 1 μm or more, more preferably 2 μm or more, and even more preferably 3 μm or more.

If r1/t1 (%) is large, there is a risk of a decrease in capacity density. Therefore, it is preferable to set an upper limit for r1/t1 (%). In this embodiment, r1/t1 (%) is preferably 1000% or less, more preferably 900% or less, and even more preferably 800% or less. Note that if “r1” and “t1” are equal, then r1/t1 (%)=100%.

On the other hand, if r1/t1 (%) is small, the contact area decreases, which may cause interface separation and lead to a short circuit. Therefore, it is preferable to set a lower limit for r1/t1 (%). In this embodiment, 1/t1 (%) is preferably 100% or more, more preferably 105% or more, and even more preferably 110% or more.

The total number of layers of the first internal electrode layers 10 and the second internal electrode layers 20 may be 2 to 200, 2 to 500, or 2 to 1000.

Of all the first internal electrode layers 10 and second internal electrode layers 20 in the multilayer chip 60, it is preferable that the relationship 0.1×t1/tan θ≤d≤2.0×t1/tan θ is satisfied for 50% or more of the internal electrode layers, it is more preferable that the relationship 0.1×t1/tan θ<d<2.0×t1/tan θ is satisfied for 70% or more of the internal electrode layers, and it is even more preferable that the relationship 0.1×t1/tan θ≤d≤2.0×t1/tan θ is satisfied for 90% or more of the internal electrode layers.

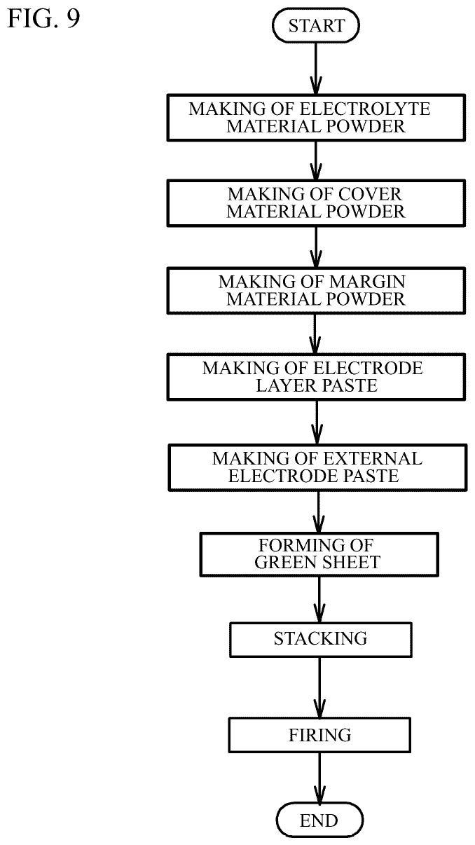

A description will be given of a manufacturing method of the all solid battery 100a. FIG. 9 illustrates a flowchart of the manufacturing method of the all solid battery 100a.

(Making process of war material powder for solid electrolyte layer) A raw material powder for the solid electrolyte for the solid electrolyte layer 30 is made. For example, it is possible to make the raw material powder for the oxide-based solid electrolyte, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mmϕ.

(Making process of war material powder for cover layer) A raw material powder of ceramics for the cover layer 50 is made. For example, it is possible to make the raw material powder for the cover layer, by mixing raw material and additives and using solid phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mmϕ.

(Making process of raw material powder for margin) Raw material powders that constitute the first margin 95a and the second margin 95b are made. For example, the raw material powder for the layer can be produced by mixing raw materials, additives, and the like and using a solid-phase synthesis method or the like. The resulting powder is subjected to dry grinding. Thus, a particle diameter of the resulting power is adjusted to a desired one. For example, it is possible to adjust the particle diameter to the desired diameter with use of planetary ball mill using ZrO₂ ball of 5 mmϕ.

(Making process for electrode layer paste) Next, internal electrode pastes for making the first internal electrode layer 10 and the second internal electrode layer 20 described above are separately made. For example, a paste for internal electrodes can be obtained by uniformly dispersing a conductive aid, an electrode active material, a solid electrolyte material, a sintering aid, a binder, a plasticizer and so on in water or an organic solvent. The solid electrolyte paste described above may be used as the solid electrolyte material. A carbon material or the like is used as a conductive aid. A metal may be used as the conductive aid. Examples of the metal of the conductive aid include Pd, Ni, Cu, Fe, and alloys containing these. Pd, Ni, Cu, Fe, alloys containing these, various carbon materials, and so on may also be used.

The additive includes sintering assistant. The sintering assistant includes one or more of glass components such as Li-B-O-based compound, Li-Si-O-based compound, Li-C-O-based compound, Li-S-O-based compound and Li-P-O-based compound.

(Making process of external electrode paste) Next, an external electrode paste for manufacturing the first external electrode 40a and the second external electrode 40b described above is made. For example, a paste for external electrodes can be obtained by uniformly dispersing a conductive material, glass frit, binder, plasticizer and so on in water or an organic solvent.

(Making process of solid electrolyte green sheet) By uniformly dispersing the raw material powder for the solid electrolyte layer in an aqueous or organic solvent together with a binder, dispersant, plasticizer and so on and performing wet pulverization, a solid electrolyte slurry having a desired average particle size can be made. At this time, a bead mill, a wet jet mill, various kneaders, a high-pressure homogenizer, or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be formed by applying the obtained solid electrolyte paste. The coating method is not particularly limited, and a slot die method, reverse coating method, gravure coating method, bar coating method, doctor blade method, or the like can be used. The particle size distribution after wet pulverization can be measured using, for example, a laser diffraction measuring device using a laser diffraction scattering method.

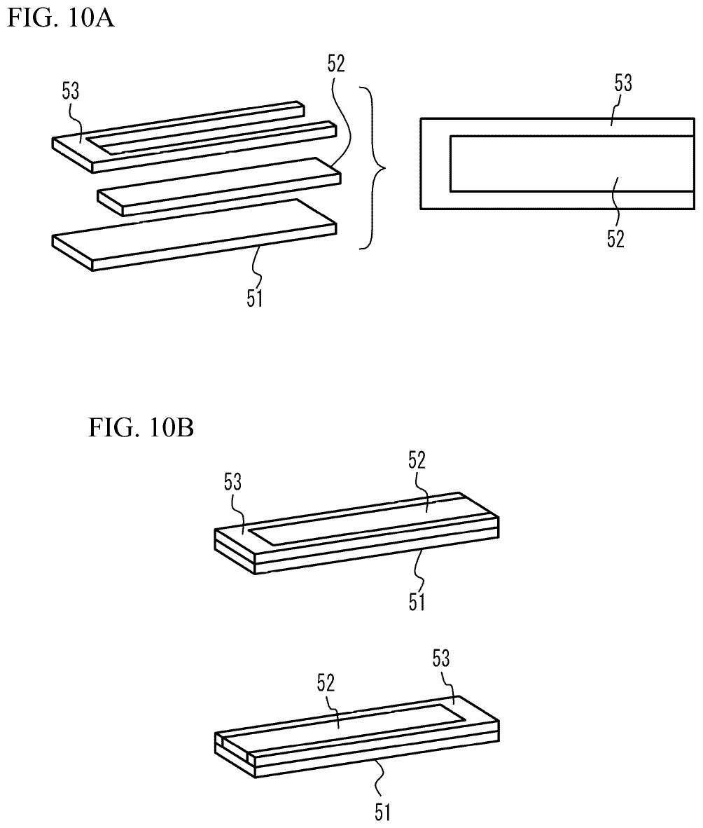

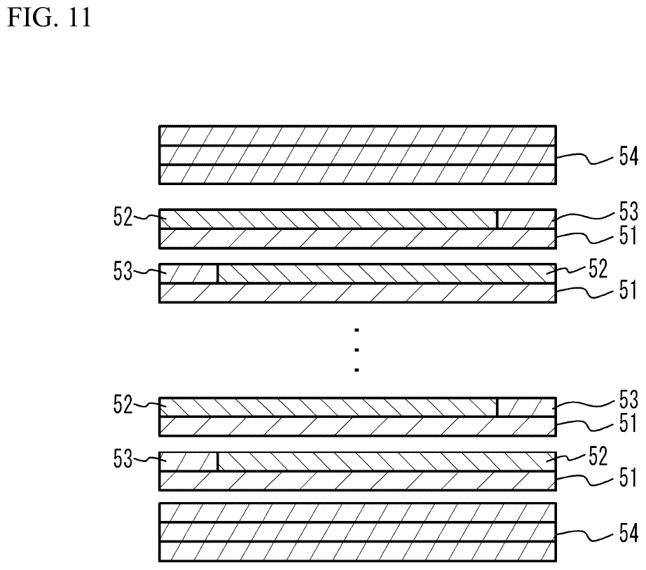

(Stacking process) As illustrated in FIG. 10A, an internal electrode paste 52 is printed on one side of the solid electrolyte green sheet 51. A margin paste 53 is printed on the peripheral area of the solid electrolyte green sheet 51 where the internal electrode paste 52 is not printed. The margin paste 53 can be formed by applying raw material powder for the margin layer using a method similar to the making process of the solid electrolyte green sheet. As illustrated in FIG. 10B, a plurality of printed solid electrolyte green sheets 51 are stacked so as to be alternately shifted. As illustrated in FIG. 11, a multilayer structure is obtained by pressing a cover sheet 54 from above and below in the stacking direction. In this case, in the multilayer structure, the internal electrode paste 52 for the first internal electrode layer 10 is exposed on one end surface, and the internal electrode paste 52 for the second internal electrode layer 20 is exposed on the other end surface. In this step, a green chip having a substantially rectangular parallelepiped shape is obtained. The cover sheet 54 can be formed by applying the raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

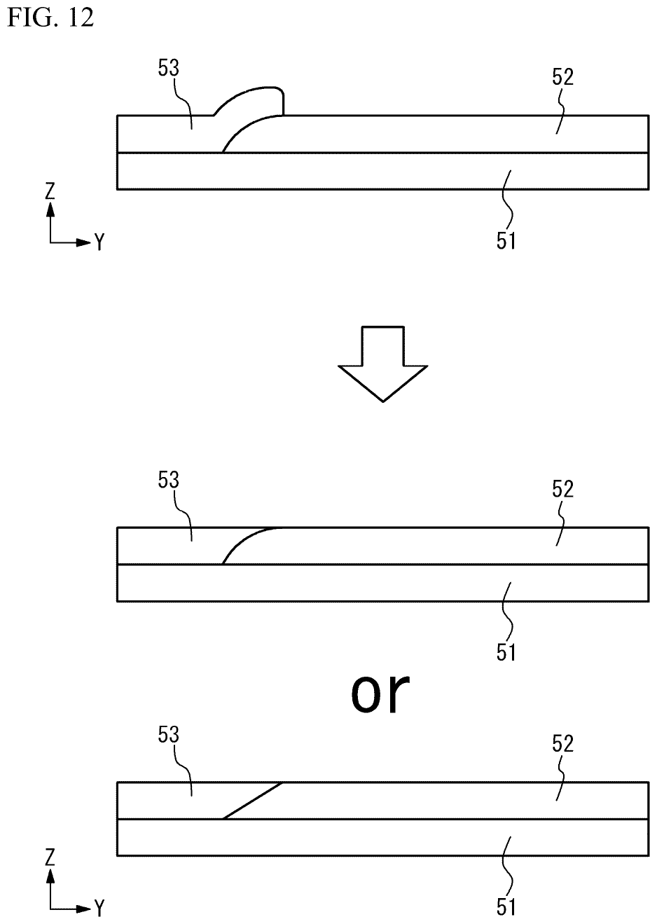

As illustrated in FIG. 12, when the margin paste 53 is printed around the internal electrode paste 52, a part of the margin paste 53 is printed overlapping the peripheral portion of the internal electrode paste 52, so that the overlapping portion 200 described in FIG. 6 can be formed after firing. The shape of the overlapping portion 200 can be adjusted by adjusting the viscosity of the internal electrode paste 52. For example, by increasing the viscosity of the internal electrode paste 52, the peripheral portion of the internal electrode paste 52 after printing rises. As a result, as explained in FIG. 7, when the tip point E1 is located on one side in the Z-axis direction in the thickness of the first internal electrode layer 10 in the YZ cross section, the external shape of the first internal electrode layer 10 becomes curved and convex on the other side in the Z-axis direction.

(Firing process) Next, the multilayer chip 60 is obtained by firing the obtained green chip. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before the maximum temperature is reached, a step of maintaining the temperature lower than the maximum temperature in an oxidizing atmosphere may be provided. In order to reduce process costs, it is desirable to fire at as low a temperature as possible. After firing, re-oxidation treatment may be performed. Thereafter, the first external electrode 40a and the second external electrode 40b are formed by applying and curing an external electrode paste on the two end surfaces of the multilayer chip 60.

According to the manufacturing method according to the present embodiment, the overlapping portion 200 described in FIG. 6 to FIG. 8 can be formed by adjusting the conditions for printing a part of the margin paste 53 on the periphery of the internal electrode paste 52.

### EXAMPLE

(Examples 1 to 5) A stack type all solid battery was manufactured according to the above embodiment. The internal electrode paste for the internal electrode layer was applied and formed on the solid electrolyte green sheet by screen printing. The margin paste for the margin was printed around the internal electrode paste on the solid electrolyte green sheet. In this case, a part of the margin paste was overlapped on the periphery of the internal electrode paste. The plurality of solid electrolyte green sheets were stacked so that the internal electrode paste was drawn out alternately to the left and right. The green chips were cut to a predetermined size to obtain a stack type all solid battery green chip. The green chips were degreased and fired to sinter them, and the external electrodes were formed by applying and hardening the external electrode paste to obtain the stack type all solid battery.

For each of Examples 1 to 5, conditions were set so that the thickness “t1” of the internal electrode layer after firing, the length “d” of the overlapping portion, and the angle “θ” would be the target values. For Examples 3 to 5, the viscosity of the internal electrode paste was adjusted so that the curvature of the outer shape of the portion where the internal electrode layer contacts the margin in the overlapping portion would be the target value.

(Comparative Example 1) In Comparative Example 1, when printing the internal electrode paste, the margin paste was not overlapped on the peripheral portion of the internal electrode paste. Conditions were set so that the thickness “t1” of the internal electrode layer after firing, the length “d” of the overlapping portion, and the angle “θ” would be the target values. Other conditions were the same as in Examples 1 to 5.

The angle “θ” explained in FIG. 6 was 15° in Example 1, 50° in Example 2, 15° in Example 3, 30° in Example 4, 50° in Example 5, and 15° in Comparative Example 1. The thickness “t1” described in FIG. 6 was 15 μm in Example 1, 50 μm in Example 2, 15 μm in Example 3, 30 μm in Example 4, 50 μm in Example 5, and 15 μm in Comparative Example 1. The length “d” of the overlapping portion described in FIG. 6 was 150 μm in Example 1, 40 μm in Example 2, 150 μm in Example 3, 80 μm in Example 4, and 40 μm in Example 5.

0.1×t1×tan θ was 5.6 in Example 1, 4.2 in Example 2, 5.6 in Example 3, 5.3 in Example 4, 4.2 in Example 5, and 5.6 in Comparative Example 1. 2.0×t1/tan θ was 112.0 in Example 1, 83.9 in Example 2, 112.0 in Example 3, 105.0 in Example 4, 83.9 in Example 5, and 112.0 in Comparative Example 1.

“r1” explained in FIG. 8 was 100 μm in Example 3, 50 μm in Example 4, and 20 μm in Example 5. r1/t1 (%) was 700% in Example 3, 170% in Example 4, and 150% in Example 5. No curvature was observed in Examples 1 and 2. These measurement results are shown in Table 1.

TABLE 1

| | | | | 0.1 × | 2.0 × | | |
|---|---|---|---|---|---|---|---|
| | θ | t1 | d | t1/ | t1/ | r1 | r1/t1 |
| | [°] | [μm] | [μm] | tan θ | tan θ | [μm] | [%] |
| COMPARATIVE | 15 | 15 | 0 | 5.6 | 112.0 | | |
| EXAMPLE | | | | | | | |
| EXAMPLE 1 | 15 | 15 | 150 | 5.6 | 112.0 | | |
| EXAMPLE 2 | 50 | 50 | 40 | 4.2 | 83.9 | | |
| EXAMPLE 3 | 15 | 15 | 150 | 5.6 | 112.0 | 100 | 700 |
| EXAMPLE 4 | 30 | 30 | 80 | 5.3 | 105.0 | 50 | 170 |
| EXAMPLE 5 | 50 | 50 | 40 | 4.2 | 83.9 | 20 | 150 |

(Quality Rate) For each of Examples 1-5 and Comparative Example 1, 300 samples with 120 layers of internal electrode layers were produced. For each of Examples 1-5 and Comparative Example 1, 300 samples were visually inspected, and those without delamination or cracks were judged as quality products. If the quality rate was 95% or higher, the quality rate was judged as good “∘”, if the quality rate was 50% or higher, the quality rate was judged as somewhat good “Δ”, and if the quality rate was less than 50%, the quality rate was judged as bad “×”.

(Short Rate) For each of Examples 1-5 and Comparative Example 1, 100 samples with 20 layers of internal electrode layers were produced. For each of Examples 1-5 and Comparative Example 1, 100 samples were inspected to see if there were any short circuits. If the short rate was 5% or less, the short rate was judged as good “∘”, if the short rate was 20% or less, the short rate was judged as somewhat good “Δ”, and if the short rate was 30% or less, the short rate was judged as bad “×”.

(Cycle characteristics) For the samples of Examples 1 to 5 and Comparative Example 1, charging and discharging were repeated at 10 C in the voltage range of 2.5V-0V at 25° C., and the cycle characteristics were determined as (200th discharge capacity/initial discharge capacity) relative to the initial discharge capacity. If the cycle characteristic was 80% or more and 100% or less, the cycle characteristic was judged as good “∘”, if the cycle characteristic was 60% or more and 70% or less, the cycle characteristic was judged as somewhat good “Δ”, and if the cycle characteristic was less than 60%, the cycle characteristic was judged as bad “×”.

(Capacitance value) The capacitance value was measured for the samples of Examples 1 to 5 and Comparative Example 1. The capacitance value of Example 3 was set to 100%, and the ratio of the capacitance value to the capacitance value of Example 3 was measured for samples other than Example 3. The measured value of Example 1 was 100%, the measured value of Example 2 was 300%, the measured value of Example 4 was 200%, the measured value of Example 5 was 300%, and the measured value of Comparative Example 1 was 70%. If the measured value was more than 100%, the capacitance value was judged as very good “double circle”, if the measured value was 80% or more and 100% or less, the capacitance value was judged as good “∘”, if the measured value was 50% or more and less than 80%, the capacitance value was judged as somewhat good “Δ”, and if the measured value was less than 50%, the capacitance value was judged as bad “×”.

(Water resistance) If the water resistance is good, the cycle characteristics will also be good, and if the water resistance is not good, the cycle characteristics will not be good either. Therefore, if the cycle characteristics is judged as good “∘”, the water resistance is judged as good “∘”, if the cycle characteristics is judged as somewhat good “Δ”, the water resistance is judged as somewhat good “Δ”, and if the cycle characteristics is judged as bad “×”, the water resistance is judged as bad “×”.

(Overall judgment) If there was no judgement as bad “×” in any of the quality rate, the cycle characteristics, the water resistance, and the short rate, the overall judge was judged as good “∘”. If there was a judgement as bad “×” in at least any of the quality rate, the cycle characteristics, the water resistance, and the short rate, the overall judge was judged as bad “×”. The results are shown in Table 2.

TABLE 2

| | CAPACITANCE | | QUALITY | | CYCLE | | | | |
|---|---|---|---|---|---|---|---|---|---|
| | VALUE | | RATE | | CHARACTERISTIC | | WATER | SHORT | OVERALL |
| | [%] | JUDGE | [%] | JUDGE | [%] | JUDGE | RESISTANCE | RATE | JUDGE |
| COMPARATIVE | 70 | Δ | 10 | X | 50 | X | X | Δ | X |
| EXAMPLE | | | | | | | | | |
| EXAMPLE 1 | 100 | ◯ | 100 | ◯ | 90 | ◯ | ◯ | ◯ | ◯ |
| EXAMPLE 2 | 300 | ⊚ | 95 | ◯ | 90 | ◯ | ◯ | ◯ | ◯ |
| EXAMPLE 3 | 100 | ◯ | 100 | ◯ | 90 | ◯ | ◯ | ◯ | ◯ |
| EXAMPLE 4 | 200 | ⊚ | 98 | ◯ | 90 | ◯ | ◯ | ◯ | ◯ |
| EXAMPLE 5 | 300 | ⊚ | 95 | ◯ | 90 | ◯ | ◯ | ◯ | ◯ |

In all of Examples 1 to 5, the overall judgment was judged as good “∘”. This is thought to be because 0°<θ<90° and the relationship 0.1×t1/tan θ≤d≤2.0×t1/tan θ were satisfied. In Comparative Example 1, the overall judgment was judged as bad “×”. This is thought to be because the relationship 0°<θ<90° and 0.1×t1/tan θ≤d≤2.0×t1/tan θ were not satisfied.

Although the embodiments of the present invention have been described in detail, it is to be understood that the various change, substitutions, and alterations could be made hereto without departing from the spirit and scope of the invention.

What is claimed is:

1. An all solid battery comprising:
a solid electrolyte layer that has a first main face and a second main face facing each other in a first direction, has a first end face and a second end face facing each other in a second direction orthogonal to the first direction, and has a first side face and a second side face facing each other in a third direction orthogonal to the first direction and the second direction;
a first internal electrode layer that is formed on the first main face of the solid electrolyte layer and is drawn to the first end face;
a second internal electrode layer that is formed on the second main face of the solid electrolyte layer and is drawn to the second end face;
a first margin that is formed around the first internal electrode layer on the first main face of the solid electrolyte layer and has a composition different from those of the solid electrolyte layer and the first internal electrode layer;
a second margin that is formed around the second internal electrode layer on the second main face of the solid electrolyte layer and has a composition different from those of the solid electrolyte layer and the second internal electrode layer;
a first overlapping portion in which a tip of the first internal electrode layer and a part of the first margin overlap each other in the third direction, viewed along the first direction; and
a second overlapping portion in which a tip of the second internal electrode layer and a part of the second margin overlap each other in the third direction, viewed along the first direction,
wherein 0°<θ<90° and 0.1×t1/tan θ≤d≤2.0×t1/tan θ are satisfied when in the first overlapping portion, an angle formed by a straight line connecting a tip point E1 of the first internal electrode layer on the first margin side in the third direction and a tip point E2 of the first margin on the first internal electrode layer side in the third direction and a straight line connecting both ends of the first internal electrode layer in the third direction is “0”, a thickness of the first margin in the first direction is “t1”, and a length between the tip point E1 and the tip point E2 in the third direction is “d”.

2. The all solid battery as claimed in claim 1, wherein “θ” is 5° or more and less than 90°.

3. The all solid battery as claimed in claim 1, wherein “t1” is 5 μm or more and 200 μm or less.

4. The all solid battery as claimed in claim 1,
wherein in a cross section including the first direction and the third direction, an outer shape of the first internal electrode layer of the first overlapping portion has a curvature.

5. The all solid battery as claimed in claim 4,
wherein in the cross section including the first direction and the third direction, an outer shape of the first internal electrode layer of the first overlapping portion has a curvature from the tip point E1 to the tip point E2.

6. The all solid battery as claimed in claim 4,
wherein when the tip point E1 is located on one side in the first direction in a thickness of the first internal electrode layer, the outer shape of the first internal electrode layer is curved so as to be convex on the other side in the first direction.

7. The all solid battery as claimed in claim 4,
wherein a radius of curvature r1 of the outer shape of the first internal electrode layer of the first overlapping portion is 1 μm or more and 500 μm or less.

8. The all solid battery as claimed in claim 7,
wherein r1/t1 (%) is 100% or more and 1000% or less.

9. The all solid battery as claimed in claim 1,
wherein a total number of layers of internal electrode layers is 2 or more and 200 or less.

10. The all solid battery as claimed in claim 1,
wherein in 90% of all internal electrode layers, 0°<θ<90° and 0.1×t1/tan θ≤d≤2.0×t1/tan θ are satisfied.

11. An all solid battery comprising:
a solid electrolyte layer that has a first main face and a second main face facing each other in a first direction, has a first end face and a second end face facing each other in a second direction orthogonal to the first direction, and has a first side face and a second side face facing each other in a third direction orthogonal to the first direction and the second direction;
a first internal electrode layer that is formed on the first main face of the solid electrolyte layer and is drawn to the first end face;
a second internal electrode layer that is formed on the second main face of the solid electrolyte layer and is drawn to the second end face;
a first margin that is formed around the first internal electrode layer on the first main face of the solid electrolyte layer and has a composition different from those of the solid electrolyte layer and the first internal electrode layer;
a second margin that is formed around the second internal electrode layer on the second main face of the solid electrolyte layer and has a composition different from those of the solid electrolyte layer and the second internal electrode layer;
a first overlapping portion in which a tip of the first internal electrode layer and a part of the first margin overlap each other in the third direction, viewed along the first direction; and
a second overlapping portion in which a tip of the second internal electrode layer and a part of the second margin overlap each other in the third direction, viewed along the first direction,
wherein in a case where in the first overlapping portion, a first tip point of the first internal electrode layer on the first margin side in the third direction is a tip point E1 and a tip point of the first margin on the first internal electrode layer side in the third direction is a tip point E2, when the tip point E1 is located on one side in the first direction in a thickness of the first internal electrode layer, an outer shape of the first internal electrode layer is curved so as to be convex on the other side in the first direction.
